(19) United States
(12) Patent Application Publication
(10) Pub. No.: US 2004/0036605 A1
(43) Pub. Date: Feb. 26, 2004

(54) Burglar alarm

(76) Inventor: Sang J. Choi, Homewood, IL (US)

Correspondence Address: SANG J. CHOI, 2425 W. 183RD ST., HOMEWOOD, IL, 60430, US

(21) Appl. No.: 10/608,955

(22) Filed: Jun. 30, 2003

Related U.S. Application Data
(63) Continuation-in-part of application No. 10/086,823, filed on Mar. 4, 2002, now abandoned.

(51) Int. Cl. G08B 13/14

(52) U.S. Cl. 340/568.1; 340/568.3

(57) ABSTRACT

An alarm system attached to an electronic device, activated by unplugging AC power cord of the alarm device from a power outlet, irrespective to the states of the main switch and the device switch. If the power cord is unplugged from the outlet, it disconnects DC continuity component from the alarm circuit, breaks a voltage divider circuit, changes the voltage level high, and activates the alarm system. The DC continuity component could be either an external component, the power transformer winding, or a device power input DC impedance. Which element is utilized is determined by the position of the main switch and the device switch. The alarm system can be turned on either by remote control or by a local switch. The alarm system is battery powered for its own circuit operation and charged by a battery charger.

### FEDERALLY SPONSORED RESEARCH OR DEVELOPMENT:

Not applicable.

### MICROFICHE APPENDIX

Not applicable

### BACKGROUND OF THE INVENTION

The importance of the protection of electronic/electrical devices from being stolen are emphasized since many such a valuable devices are used in hospitals, schools, and laboratories. Various alarm apparatus systems are invented and produced to fulfil the necessity arisen from the experiences that those expensive devices have been lost. There are many different ways to activate an alarm system by using different type of sensors or radio communication devices. Sensors have their inherent lapse in adjusting their sensitivity. If a sensor is adjusted too sensitive, it may cause false alarm while if it is adjusted too loosely, it may miss a triggering of the alarm. Some alarm systems use a motion detector as an alarming initiator. The installation of the detector itself requires a quite of work.

As of U.S. Pat. No. 5,767,771, unplugging a power cord from a outlet arms an alarm system. Lamont's system is actually activated by a motion sensor or a tempering switch like so many other alarm systems. When the main switch is turned off, the alarm circuit is on the stand by state, and unplugging the power cord does not affect the alarm circuit operation at all. The present system is actually activated by unplugging the power cord irrespective to the state of the main switch. The two systems, present invention and Lamont's system, are quite different functionally and in physical structure. Present invention and so many other systems are armed by simply turning power switch on. Lamont's system does not have a mechanism to turn the alarm off, once it is activated. My system will be turned off automatically after the predetermined period of time set by the timer circuit (34). The voltage level detector circuit in this invention detects whether the power cord is plugged or unplugged. Once it detects the disconnection of AC plug, it triggers timer circuit and activates the alarm. Alarming duration is determined by the RC timer circuit. Optionally, alarming duration can be extended until the system is turned off. In U.S. Pat. No. 4,736,195, McMurtry used comparator circuit. However, he used very complicated associated circuit that requires much more difficult design criteria. As of McMurtry system, as long as the main switch (320) is on, the alarm system is not working. The system also requires an AC signal generator, frequency divider, switch circuit. Designing those circuits must go through lots of trial and error process. If the diode (323) is a typical diode structure, it's forward voltage drop is 0.7 volts. The collector of the transistor (308) does not have much room for the voltage change. It looks simple but hard to set appropriate voltage level without false triggering, especially when AC is superimposed on the DC level.

The arrow headed side of power switch (320) is connected to the power transformer, which is connected in parallel with the appliance circuit. That is why if the switch (320) is closed, the alarm system does not work. Alarm will be on when the flip-flop (324) is on state. As the solution of all the aforementioned shortcomings of an alarm device, the present invention utilizes the method of unplugging power cord for activating an alarm system as explained in the summary part and in the detailed description section.

### SUMMARY OF THE INVENTION

The present invention is regarding to a burglar alarm means which will be activated by unplugging the power cord connected to an alarm means and an electronic/electrical device in parallel. A voltage level detector circuit is checking the state of the power cord connection constantly. When the cord is unplugged or broken, it will generate a right polarity of output to said alarm apparatus. The alarm activator circuit inverts the detector output to the opposite polarity. Timer circuit is responsible to control the time length how long the alarm will be turned on. The power amplifier amplifies the output current to provide enough power to drive the sound device. The novel feature of this invention is the way activating an alarm device which is securely fastened or attached to an electronic/electrical apparatus. If a person try to move an electronic device from one location to another location, one should unplug the power cord from a power cord outlet. This will also disconnect the AC power from the alarm device and activate it because when the electronic device is unplugged, the alarm device is also unplugged. This method is quite different from the most other features such as motion sensor, infrared sensor, or shock sensor. Those sensing devices are very critical to adjust the sensitivity. The present invention's method to initiate an alarm condition is very straightforward, plugged or unplugged, no gray area. The sound device can be a speaker, buzzer, horn, chime, or any other noise generating apparatus. This invention will provide an alarm system which is economical to manufacture, easy to use and install, and versatile in it's function. To conserve the battery voltage, this system uses the CMOS devices for the voltage level detector, alarm activator, and the timer circuit. Optionally, this system uses a voltage charger circuit to charge the battery voltage.

### BRIEF DESCRIPTION OF THE DRAWINGS

FIG. 1 is a detailed schematic of the present invention.

FIG. 2 is a connection diagram of a power outlet strip, an alarm device, And an electronic device.

FIG. 3 is showing how power cords are connected to an electronic/electrical device and to an alarm apparatus of this invention.

FIG. 4 is showing that said alarm device is mounted inside the housing (case) of said electronic device.

FIG. 5 is illustrating that said alarm circuit is included on the Printed Circuit Board of said electronic device.

### DETAILED DESCRIPTION OF THE PREFERRED EMBODIMENT

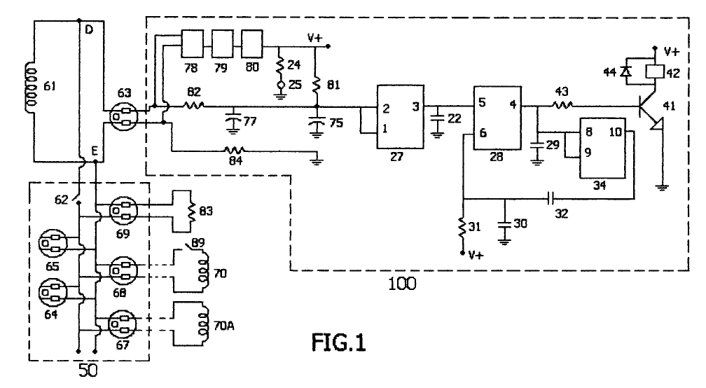

Referring to FIG. 1, it illustrates the schematic diagram showing in detailed level for the present invention of an alarm system designed to protect an electrical or an electronic apparatus from being burglarized. This circuit uses a battery (79), which provides the necessary power for the operation of the whole alarm circuit, and is charged by a battery charger (78).

All components value should be chosen such a way it saves power consumption during quiescent state. When switch (80) is closed, the battery voltage is connected to the alarm circuit and the LED (25) is lit. The resistor (24) is current limiting resistor to protect the LED (25).

(61) is AC input transformer winding, which connects AC voltage to multi power outlet strip (50), and single power outlet (63) which is connected to the transformer directly without going through a switch.

(62) is main switch for the power outlet strip (50). Items, (63), (64), (65), (59), (67), and (68) are parallel connected power outlets.

(100) is alarm device circuit which includes AC cord status detection circuit and alarm activating circuit. Two power outlets (63, 68) are required for protecting an electrical or electronic device, one for the device and the other one for the alarm circuit. However, if an extra outlet can not be found, the power cord for the alarm device can use the outlet being used by the electronic device. To use the present alarm system, an electronic device does not have to be plugged. Irrespective to the position of the main switch (62), if cords for outlets (63) and 64 are unplugged to remove the device (70), the voltage level detector (27) output will be changed to opposite state, this state change will trigger the alarm system. Item (70) is shown to illustrate that if the input circuit of a device (such as computer) is DC open. Outlets (65) and (64) can be used for the same purpose for another device. This arrangement can be applied as many as needed. The outlet (69) is used to connect a 20K ohms 1W continuity resistor to provide a complete DC path for the alarm cords connected into the outlets of the multiple power strip (50). This DC path provides appropriate voltage drop across R82, R83, and R84, which is applied to the input of voltage level detector (27). If the outlet (63) is plugged, this voltage remains as low level. If the (63) is unplugged, this voltage is changed to high level. (78) is battery charger and (79) is a battery which provides the necessary power for the alarm side circuit. Capacitor (75) is a filtering capacitor, which filters (60) HZ AC components from entering to the inputs of the voltage level detector (27). Capacitors (77), (22), (30), (29) are high frequency filtering capacitors. These capacitors prevent false alarming caused by high frequency noise signal. The main part of the voltage level detector is a NAND GATE and associated circuit. A NOR GATE or an inverter can be used for the same purpose. A comparator also can be employed for this purpose. However, it consumes more power. That is why a NAND GATE is preferred over a comparator for this application. The two inputs of the NAND GATE are tied together and receive only one input for the pin (1) and pin (2). The input voltage is derived from the voltage divider circuit consisted of (81), (82), (83), and (84). If input at (27) is low level, the output of (27) is at high level. To meet this requirement (low output), the power cord for the alarm device should be unplugged, and the voltage level on the input of (27) is at high level. The main part of the alarm activator is another NAND GATE with two separate inputs, one from voltage level detector (27) for activating the alarm state, and another one from the timer circuit to control the timing duration of the alarming. The output of (28) activates the alarming circuit and initiates the timing of the alarming. If (63) is a wall outlet connected directly to the transformer winging (61) as shown in the Figure, (83) is not needed, because the transformer winding of (61) provides the necessary continuity for the voltage divider circuit of (81), (82), and (84). If the alarm circuit (100) is using the power outlet (65) instead of (63), and none of the apparatus, connected across power outlets strip (50), has low input impedance (below 20K ohms) and the switch (62) is open, then continuity component (83) should be installed. The continuity component (83) could be either a resistor, or an inductor, or a transformer winding which provides DC current path. If the power plug for the alarm device (100) is connected as shown, any time the plug is disconnected, it will set the alarm. If (100) is a connected into (65), and switch (62) is open, and appliance (70A), which has the closed input impedance, is connected, external continuity component (83) is not needed. However, if (83) is connected, for all cases, the alarm system will be activated by unplugging the power cord of the alarm device. Under normal operation where power cord of the alarm device (100) is plugged, the input to the voltage level detector (27) is low level and the output of the alarm activator (28) is at low level and the alarm device is deactivated. If the power plug of the alarm (100) is unplugged from either outlet (63) or outlet (65), the input voltage to (27) is high level and the output of (28) is high level and triggers the alarm circuit (41 and 42).

The outlets (64) and (65) can be used for some other apparatus. When the alarm is activated, the output of the timer (34) is at low level, and capacitor (30) and resistor (31) keeps the input terminal (6) of (28) below the threshold level keeping the alarm system activated for the period determined by (31) and (32) even though the power plug is connected back. The same functions can be accomplished with two logic GATES instead of three logic GATES, (27), (28), and (34). However, with one additional GATE, more stable operation can be accomplished.

Resistor (43) is the current limiting resistor for the current driver transistor (41). When transistor (41) is turned on, a buzzer or a speaker, or any other noise generating device (42) will make a noise. The diode (44) is to remove a high positive pulses from the collector of the power transistor (41), which may damage the transistor.

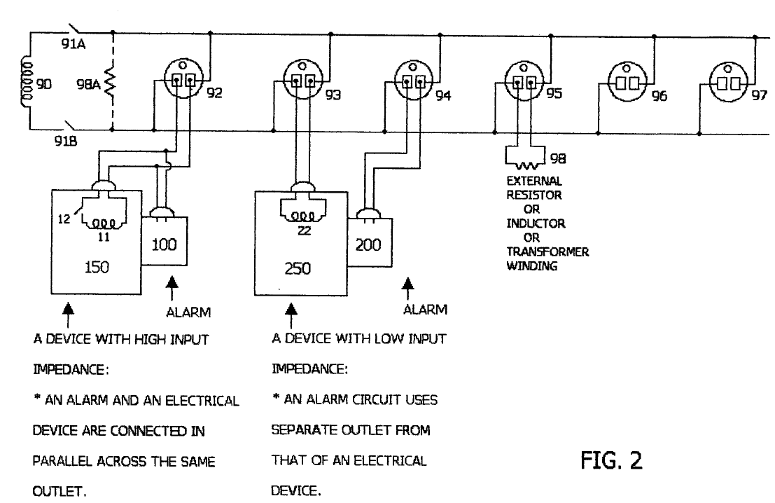

FIG. 2 shows the connection diagram of power outlet assembly, electronic/electrical devices, and alarm apparatus.

Item 90 is a transformer winding across which AC voltage is delivered, 91A and 91B are main switches, 98 and 98A are external resistors, out of the two resistors, only one resistor is connected depending upon which place is easy and convenient to install.

An electronic device (150) and an alarm system (100) both are connected to the same power outlet (92) in parallel. In this case, the input impedance of the device is very high or open circuited as shown by items (11) and (12). Many personal computers have this kind of features for the AC power input. The alarm system (100) is securely attached to the electronic device.

Another electronic device (250) is connected to the power outlet (93) and another alarm system (200) is connected to the power outlet (94). The power-input impedance of the device is very low as shown by item 22, that is why they are using separate power outlets for the external resistor not to be shorted out. External resistor (98) is connected to the power outlet (95). It is easy to connect the resistor across a power outlet. However, it can be connected next to power switch, if so desired, or any convenient place across two power wires between main switch and any power outlet. The power outlets (96 and 97) can be used for another electronic device and an alarm system combination.

More power outlets can be added according to the necessity.

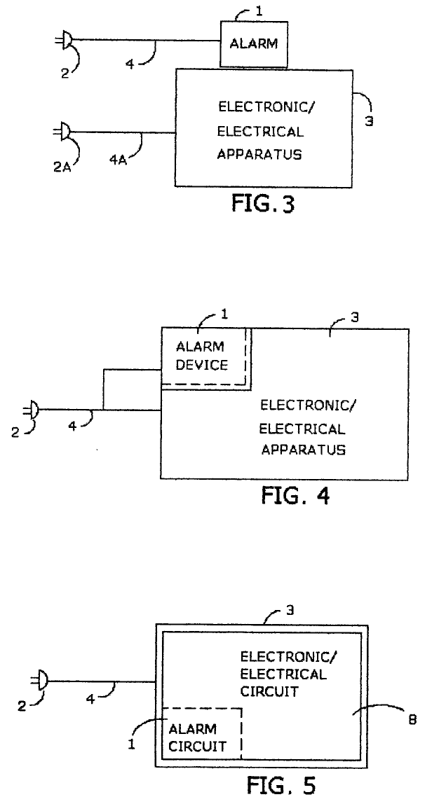

FIG. 3 shows an alarm device (1) of this invention mounted on an electronic/electrical device (3). Epoxy glue or some other type of double face adhesive strips can be used for attaching securely the alarm device to an electronic apparatus, or special case (housing) can be made with appropriate mounting bracket on it. FIG. 3 also shows the way power cords are connected. To move said electronic device (3), the cord (4) connected to said alarm device should be unplugged or broken because said alarm (1) is securely attached to the electronic device (3). This will activate the alarm.

FIG. 4 is showing that said alarm (1) is mounted inside the housing of the electronic device (3). A split power cord (4) is directly connected to any available power outlet. Said alarm device may be mounted on an inconspicuous place inside or outside of said electrical apparatus (3).

FIG. 5 illustrates that said alarm circuit (1) is assembled on a portion of the printed circuit board (8) of said electronic device (3) during manufacturing process.

In the broader aspects, this invention is not limited to the specific embodiment illustrated and described herein.

Those skilled in the art may make various changes and modifications without departing from the scope and spirit of the present invention. It is the expressed intention of this invention to embrace all such changes and modifications which fall within the scope of the described claims thereby.

What I claim is:

1. A burglar alarm apparatus, attached to an electronic or electrical device, activated by unplugging a power cord connected to said alarm means, irrespective to the state of a main switch or the device switch, comprising: a battery for providing power to the alarm circuit; power switch means for enabling or disabling said alarm either by locally or remotely; voltage charger means for charging the DC battery; a voltage divider circuit and filter circuit to provide an appropriate voltage level to a voltage level detector, wherein the voltage level will be drastically changed when the power cord of the alarm is disconnected from the power outlets; a voltage level detector for producing an appropriate voltage level either high level or low level depending upon the power cord states unplugged or plugged; an alarm activator for providing the appropriate output polarity, representative of the state of the power cord; a timer circuit for determining the time duration during which the alarm is activated; a driver for amplifying the output current high enough to drive the sound device; sound device for generating audible sound; a power cord for connecting said alarm device to power source means; a case for housing the apparatus; and mounting means for attaching said alarm apparatus to the electronic or electrical device.

2. A burglar alarm apparatus according to claim 1, wherein a voltage charger is for charging the DC battery voltage and the power switch is either remotely controlled switch or locally operative switch.

3. A burglar alarm apparatus according to claim 1, wherein the voltage divider circuit includes a DC continuity component, external to the alarm circuit, connected across two power lines on any convenient place between main switch and any power outlet, parallel to the power outlet into which the power cord of the alarm device is connected.

4. A burglar alarm apparatus according to claim 1, wherein, if the power cord of the alarm device is connected into a hot wall outlet, the continuity component is not needed.

5. A burglar alarm apparatus according to claim 1, wherein, if the DC power input impedance of any electronic/electrical device is low and the device is controlled by the same power switch used by the alarm device, the external continuity component is not needed.

6. A Burglar alarm apparatus according to claim 1, wherein said level detector and the alarm activator triggers the sound circuit when the power cord of the alarm device is unplugged.

7. A burglar alarm apparatus according to claim 1, wherein the activated alarm state can not be deactivated by plugging the power cord back. Once activated, the alarming state continues until the time elapsed determined by the timer circuit.

8. A burglar alarm apparatus according to claim 1, wherein, as long as the power cord of the alarm device is connected into a hot power outlet, the alarm is activated when the cord is unplugged, irrespective to the states 1) of any switches, 2) of external continuity component connection, 3) of the power cord connection of an electronic device, which the alarm device is attached to.

9. A method of activating an alarm apparatus that is securely attached to an electronic or electrical device, irrespective to the positions of the main switch or the device switch, by unplugging the power cord connected to said alarm apparatus from a power outlet.

10. A method of activating an alarm apparatus according to claim 9, connecting a DC continuity component in parallel with the power outlet, external to the alarm circuit, to nullify the effect of the states of the main switch or the device switch.

11. A method of activating an alarm apparatus according to claim 9, attaching the alarm device securely to the electronic devices, causing alarming sound to follow physically the electronic devices being removed (or stolen).

12. A method of activating an alarm apparatus according to claim 9, taking the place of the external continuity component by a power transformer winding, which connects induced AC voltage directly to the power outlet where the power cord of the alarm device is connected.

13. A method of activating an alarm apparatus according to claim 9, taking the place of the external continuity component by a low input impedance of the electronic device, which the alarm device is attached to.

14. A method of activating an alarm apparatus according to claim 9, plugging the power cord of the alarm device into the hot power outlet, from which the electronic device is removed. The electronic device don't have to be turned on to activate the alarm device.

15. A method of activating an alarm apparatus according to claim 9, embedding alarm circuit as part of an electronic or electrical device circuits, wherein the alarm means is activated when the common power cord of said device and alarm circuit is disconnected from a power outlet, irrespective to the positions of main switch or the device switch.
